(19) United States
(12) Patent Application Publication
(10) Pub. No.: US 2009/0249983 A1
(43) Pub. Date: Oct. 8, 2009

(54) Gliding table and chairs

(76) Inventor: Rurong He, Duluth, GA (US)

Correspondence Address: Roderic N. Uphaus, 103 Dendron Av., Troy, AL, 36081, US

(21) Appl. No.: 12/078,897

(22) Filed: Apr. 8, 2008

(51) Int. Cl. A47B 83/02; B60B 33/00

(52) U.S. Cl. 108/50.11; 16/47

(57) ABSTRACT

A style of lawn glider that consists of a table and chairs which travel forward and backward as one gliding frame over a second lower frame which rests on a reasonable flat surface. The use of four hard wheels, which roll in between four lower concave tracks that are part of the lower frame and four convex tracks that are part of the upper frame, provide the gliding action. The lower frame provides a retractable transport wheel system that allows easy relocating of the entire mechanism. A cloth guard system provides a way of preventing unintentional contact with moving parts. The current glider is made of wood and common fasteners, but it could be made of other materials such as plastic, metal or composite materials. Seat cushions and overhead sun shade are considered part of this product. The glider is designed to be packaged and sold in a kit form.

### CROSS-REFERENCE TO RELATED APPLICATIONS

Not Applicable

### REFERENCE TO A “MICROFICHE APPENDIX”

Not applicable

### BACKGROUND OF THE INVENTION

1. Field of the Invention

The present invention relates to a new and improved quick assembly Gliding Table and Chairs with transporting wheels. This design will be used in commercial establishments such as restaurants and lounges as well as by home owners. The Gliding Table and Chairs will provide a relaxing environment as Patrons glide forward and backward as they socialize.

2. General Background of the Invention

People in general very often employ the use of commercially available picnic tables, lawn tables and dinner tables as well as the bench seats or chairs to go along with the tables. Some of the most popular sources for this style of product would be Lowes www.lowes.com, Home Depot www.homedepot.com and Costco www.costco.com.

Designing and fabricating a Gliding Table and Chairs is far more challenging, costly and time consuming than most consumers can afford. Therefore the following invention is introduced.

### BRIEF SUMMARY OF THE INVENTION

The present invention provides a mobile gliding table and bench seats comprised mostly of wood but not limited to wood or plastic. The Gliding Table and Bench seats allow the user to feel as if they were gliding on air as they move forward and backward while seated on the bench style chairs.

The present invention is provided in a kit form. The kit consists of only large preassembled components. The large preassembled components are then bolted together to form the complete apparatus. The apparatus is generally rectangular in shape and consists of an upper and a lower assemble. The upper assembly consists of a centered table and bench seats. When assembled, the upper components form the rectangle frame. The seats are positioned near the ends of the long portion of the rectangle frame.

The lower assembly consists of a generally rectangle assemble. Symmetrical in size to the upper assembly. The lower assembly consists of two floor board assembles and outer segments which form an exterior rectangle frame, which, when in use, is positioned on a flat generally level surface.

In use, the upper assembly rides over the lower assembly on four wheels located near each opposing corner of the apparatus. The upper assembly has four convex tracks, one each located along the inner edge near the end of the long portion of the rectangle frame.

The lower frame has four concave tracks symmetrically located along the inner edge near the end of the long portion of the rectangle frame. Thereby when the wheels are placed in each corner they have an upper and lower track to travel in, found on the upper and lower assembles. Along the outer edge of each track is a side board which keeps the wheels contained within the upper and lower assembles. Along the inside edge of each said lower track there is a timing chain affixed to the frame following the same concave shape as the track.

Axle assemblies consisting of an axle, two timing sprockets and two hard wheels are placed in the concave track and timing chain of the lower frame. The axle's position is then parallel to the rear short portions of the rectangle frame.

The sprockets track within the timing chain urging the axle and wheels to stay in a parallel position to the rear rectangle frame. The upper frame assembly is then positioned symmetrically over the lower frame on the hard wheels.

The axle and wheel assemblies track within the upper convex and the lower concave tracks.

The operator gently applies pressure to the lower floor deck assembly with their feet. This produces a forward and backward motion as the axle and wheel assembles move within the tracks. By virtue of the concave and convex tracks, the use of gravity, kinetic energy is employed. The kinetic energy stored in each influenced stroke is enough to keep the glider in motion for approximately six following strokes.

The complete gliding table assembly employs cloth guards along the outer edge of the longest portions of the rectangle frame. The said guard is affixed to the upper assembly and covers an area between the upper assembly and the lower assembly. This area is a space approximately one inch in width and is the length of the mechanism. The gliding wheels travel along this area as the glider moves forward and backward protected from unwanted contact of persons by the cloth guard.

Cloth guards are also employed under each seat assembly. The cloth guards cover the axle assemblies containing the sprockets and hard gliding wheels preventing contact with moving parts by persons.

The entire Gliding Table mechanism can be relocated on four retractable wheel assembles. These said wheels are located under the floor board assembles.

Two said wheels are affixed to each of two axle assemblies. The said axle assemblies are affixed to the floor board frames on each end of the floor board assembly. The sole propose of the axle is to rotate and hold the wheel assembles into the transport position or to rotate retract them to the stored position.

The said axles are rotated into position by connecting rods. Positioned generally centered of these said rods and centered in the floor boards is a cantilever twisting mechanism. This twisting mechanism is rotated by a separate crank handle. When this mechanism is twisted, it urges the connecting rods inward and into an over center locking position. As the connecting rods are urged inward, the axle and wheels are twisted lifting the Gliding Table assembly onto the transport wheels. Affixed to one of the connecting rods is a spring which helps urge the table into the lifted position. The wheels in this position would be considered in the locked position.

Rotating the crank mechanism in the opposite direction then pushes the connecting rods outward causing the wheels to retract and lower the table to the usable position.

### BRIEF DESCRIPTION OF SEVERAL VIEWS OF THE DRAWINGS

For a further understanding of the nature, objects, and advantages of the present invention, reference should be had to the following detailed description, read in conjunction with the following drawings, wherein like reference numerals denote like elements:

FIG. 1 is a perspective elevation view of the preferred embodiment of the apparatus of the present invention, generally positioned for operation.

FIG. 2 is a partial exploded prospective view of the preferred embodiment of the apparatus of the present invention.

FIG. 3 is a prospective of the lower frame of the apparatus of the present invention.

FIG. 4 is a prospective side view without guards of the preferred embodiment of the apparatus of the present invention.

FIG. 5 is a prospective elevated view with operator on the preferred embodiment of the apparatus of the present invention.

FIG. 6 is an exploded view of the upper assembly of the preferred embodiment of the apparatus of the present invention.

FIG. 7 is a lower, end ward, side view of the upper assembly of the preferred embodiment of the apparatus of the present invention.

FIG. 8 is an exploded view of the lower assembly of the preferred embodiment of the apparatus of the present invention.

FIG. 9 is a separated prospective side view of the lower frame and the floor board assemblies of the apparatus of the present invention.

FIG. 10 is a prospective upper/end/side view of the lower frame and foot board assembly of the apparatus of the present invention.

FIG. 11 is a prospective under side view of the foot board assembly with transport wheels lowered of the apparatus of the present invention.

FIG. 12 is a prospective under side view of the foot board assembly with transport wheels locked in transport position of the apparatus of the present invention.

FIG. 13 is a prospective view of a lower assembly track with axle sprocket and wheel located on a track and timing chain with timing marks together of the apparatus of the present invention.

FIG. 14 is a prospective view of the axle, sprocket and wheel traveling rearward in the lower and upper assembly tracks of the apparatus of the present invention.

FIG. 15 is a prospective view of the axle, sprocket and wheel in the fully rearward position against travel stop with lower foot guard removed for viewing of the apparatus of the present invention.

FIG. 16 is a prospective view of a cloth guard installation under the rear of a bench seat of the apparatus of the present invention.

FIG. 17 is a prospective view of the crank handle for use in the transport wheel mechanism of the apparatus of the present invention.

FIG. 18 is a prospective view of the twisting transport lift mechanism for the transport wheel mechanism of the apparatus of the present invention.

### DETAILED DESCRIPTION OF THE INVENTION

FIGS. 1, 4 and 5 show generally the preferred embodiment of the apparatus of the present invention comprising of 20 Upper frame assembly, 21 lower frame assembly, and 23 Axle and gliding wheel assembly.

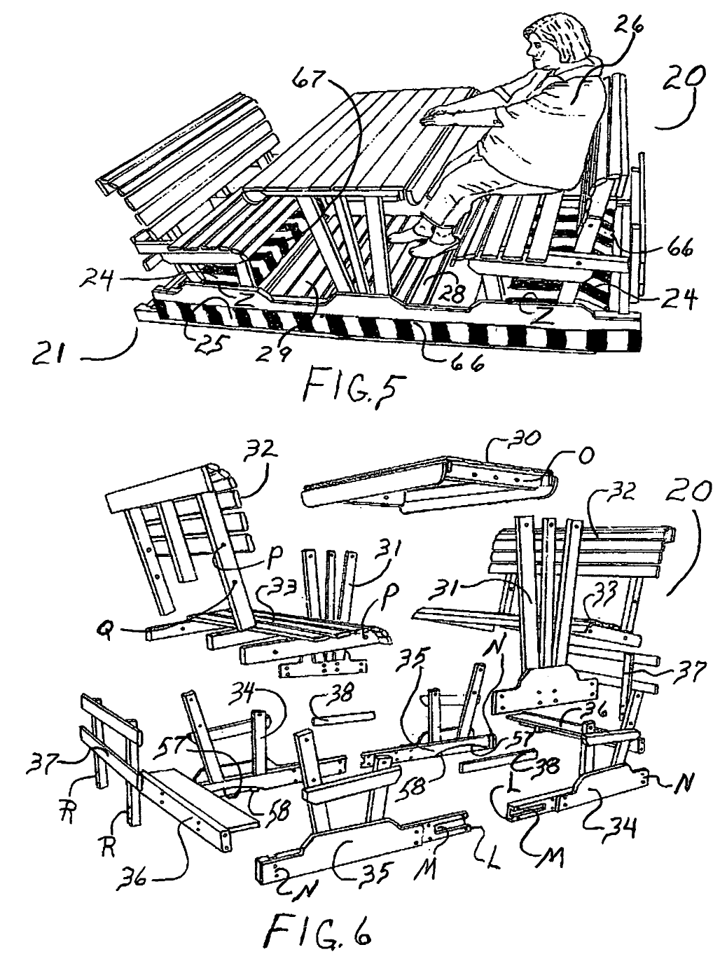

20 upper frame assembly is best depicted in FIGS. 6 and 7 wherein two individual components are formed from one each of 34 Left seat gliding frame and 35 Right seat gliding frame are positioned with point L touching ends. 38 Key board is located in M Key board pocket. The 31 Table leg is positioned over 34 Left seat gliding frame, 35 Right seat gliding frame and 38 Key board. Six fasteners E affix 34 Left seat gliding frame, 35 Right seat gliding frame, 38 Key boards and 31 table leg together across the face of 31 Table leg.

36 Rear cross support, 35 Right seat and gliding frame, and 34 left seat gliding frame are affixed with hardware D at location N on face of 35 Right seat and face of 34 Left seat and gliding frame to form the upper rectangle frame.

30 Table top is affixed to 31 table legs with hardware B at common locations O. 33 Seat bottoms position upon 34 left seat and gliding frame and 35 Right seat and gliding frame. 32 Seat backs position along the inside upper members of 35 Right seat and gliding frame and 34 Left seat and gliding frame. 33 Seat bottoms and 32 seat backs are affixed to 34 Left seat and gliding frame and 35 Right seat and gliding frame by fasteners B in common locations P and fasteners A in common locations Q. 37 Rear guard is affixed to 36 Rear cross support by common fasteners C in common positions R, thus forming 20 Upper frame assembly.

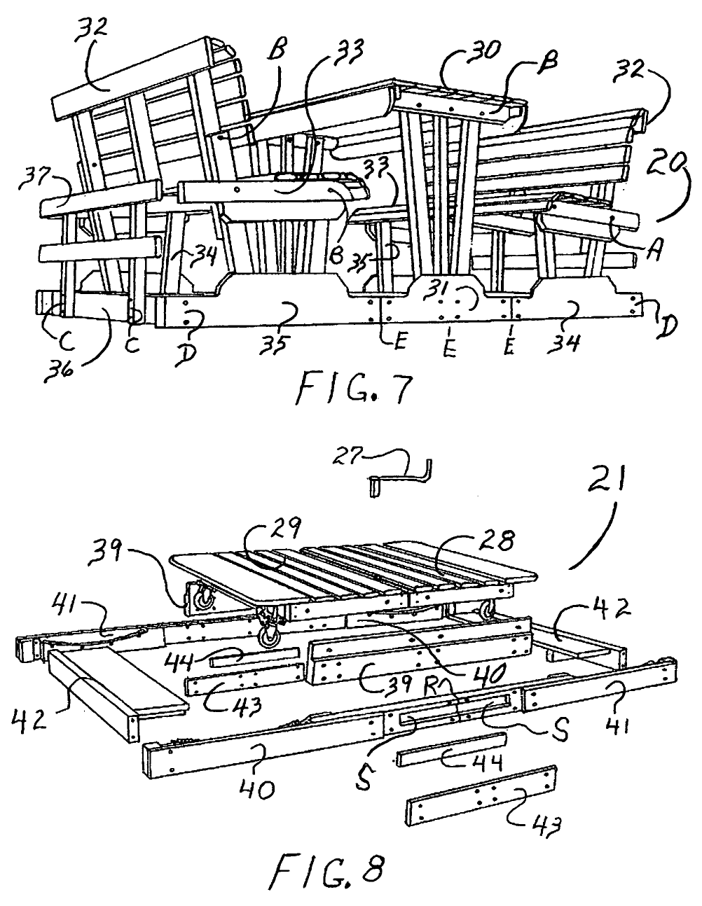

21 Lower frame assembly best depicted in FIGS. 8, 9 and 10. Describe the combination of components that form the generally rectangular lower frame long sides. 40 Right gliding frame with timing chain and 41 Left gliding frame with timing chain are positioned as viewed at location R on FIG. 8. 44 Key boards are placed into 1 Key board pockets. 43 Frame locking side board is located over the 44 key board pocket and in between an area provided by 40 Right gliding frame with timing chain and 41 Left gliding frame with timing chain. 39 Foot board riser board is positioned on the opposite side of 43 Frame locking side board, against 40 Right gliding frame with timing chain and 41 Left gliding frame with timing chain.

Fasteners H affix the components at positions T, FIG. 10, to form two opposing Lower main frame sides. 42 Rear cross supports and foot guard are affixed at each end in pockets provided with hardware D at positions U on 40 Right gliding frame with timing chain and 41 Left gliding frame with timing chain.

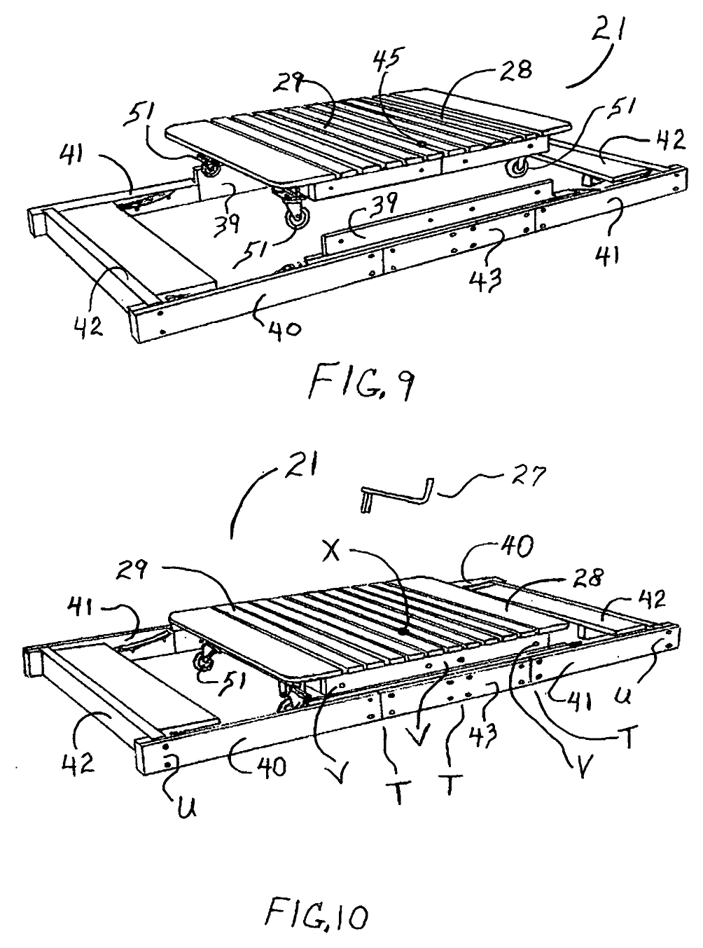

28 Foot board and lifting mechanism with transport wheels and 29 Foot board with transport wheels are positioned between 39 Foot board riser boards so that the transport wheels are positioned outwardly; this is best depicted in FIGS. 9 and 10. 28 and 29 Foot boards are affixed at common locations V, FIG. 10, by hardware G.

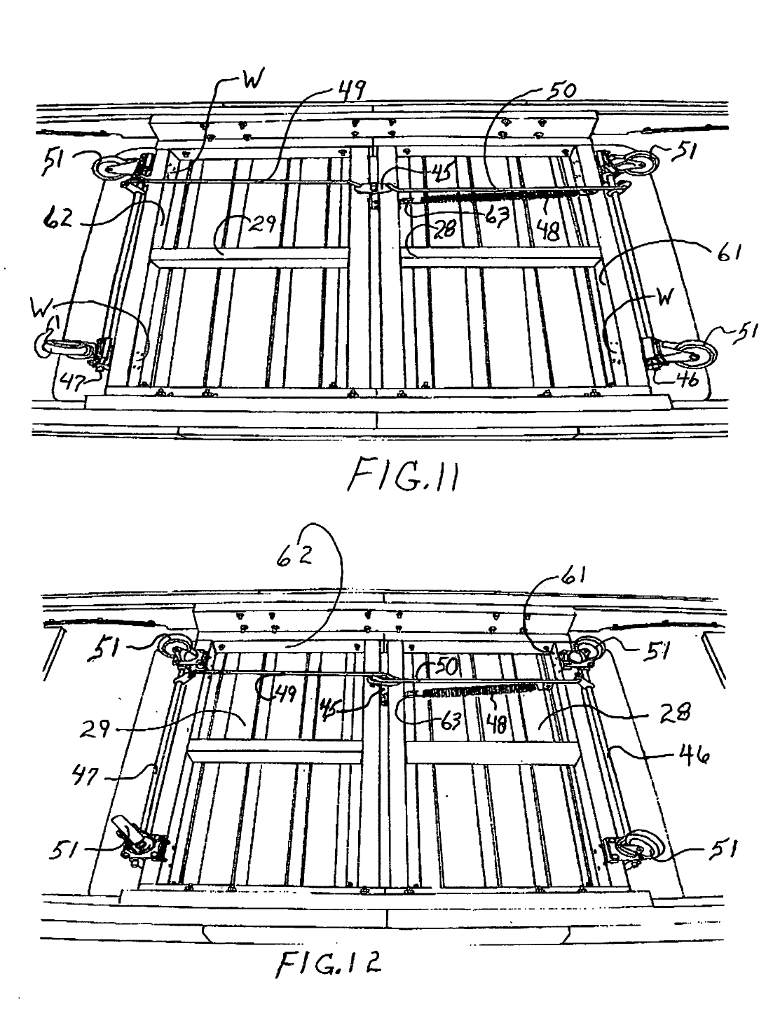

To better describe foot boards: FIGS. 11 and 12 Show the under side of the apparatus 28 and 29 Foot boards. 28 Foot board and lifting mechanism employ 45 Twisting transport lift mechanism shown in FIG. 18 which is affixed to frame 61 Wooden frame assembly. 50 Lifting connecting rod with spring bracket is pivotally mounted to 45 Twisting mechanism and 46 Transport wheel axle assembly. A 48 extension spring is hooked to a portion of 50 Lifting connecting rod at one end and extended to and hooked onto 63 Eye bolt on the opposite end, which is affixed to frame 61.

The 46 transport wheel axle assembly is pivotally mounted to 61 wooden frame assembly at common locations W, as viewed on FIG. 11, with the transport wheels in the relaxed position. From the top side of the foot board assembly, 27 crank is inserted into the twist mechanism 45 at position X on FIG. 10. As it is rotated clockwise, it urges 50 lifting connecting rod with attached assist spring and 48 and 49 lifting connecting rod inward and past a center point of the rotation into a binding locking position. At the same time counter rotating. 46 Transport wheel axle assembly and 47 opposite Transport wheel axle assembly, so that the affixed 51 Transport wheels are urged in contact with the opposing surface, producing a lifting action of the 21 Lower frame assembly.

Once the 45 Twisting mechanism is in the locked position as depicted in FIG. 12, the entire Gliding Table and Chairs can be rolled to a desired location. Once the Gliding Table and Chairs are relocated, the 27 Crank can be reinserted into mechanism 45 at position X and rotated in the opposite direction, now urging the retraction of 51 transport wheels and the lowering of the entire Gliding. Table and Chairs.

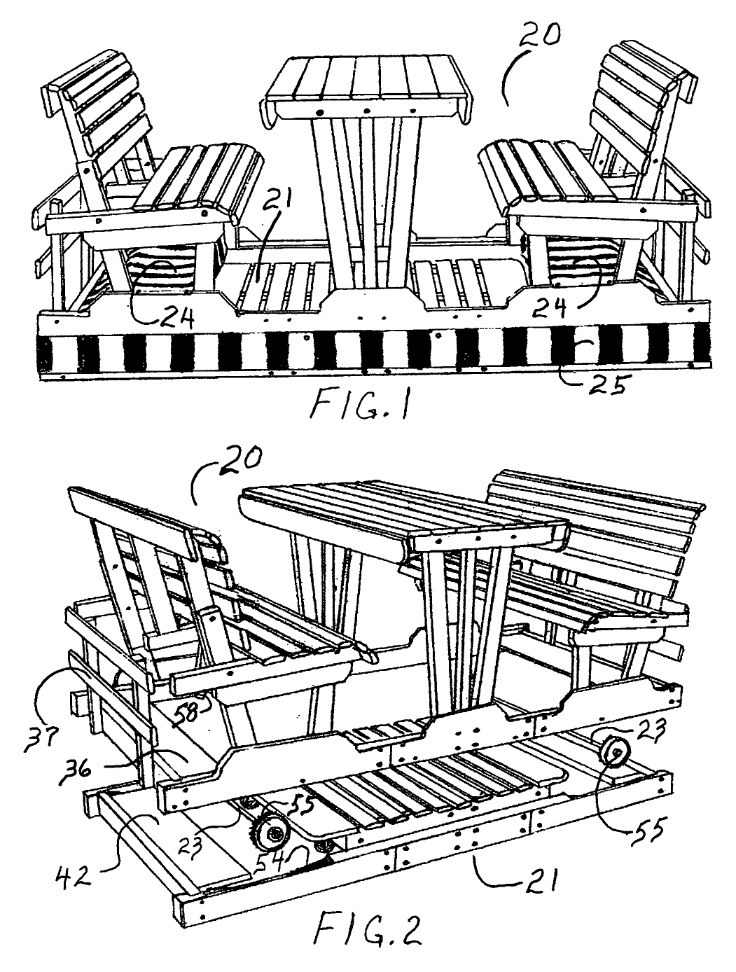

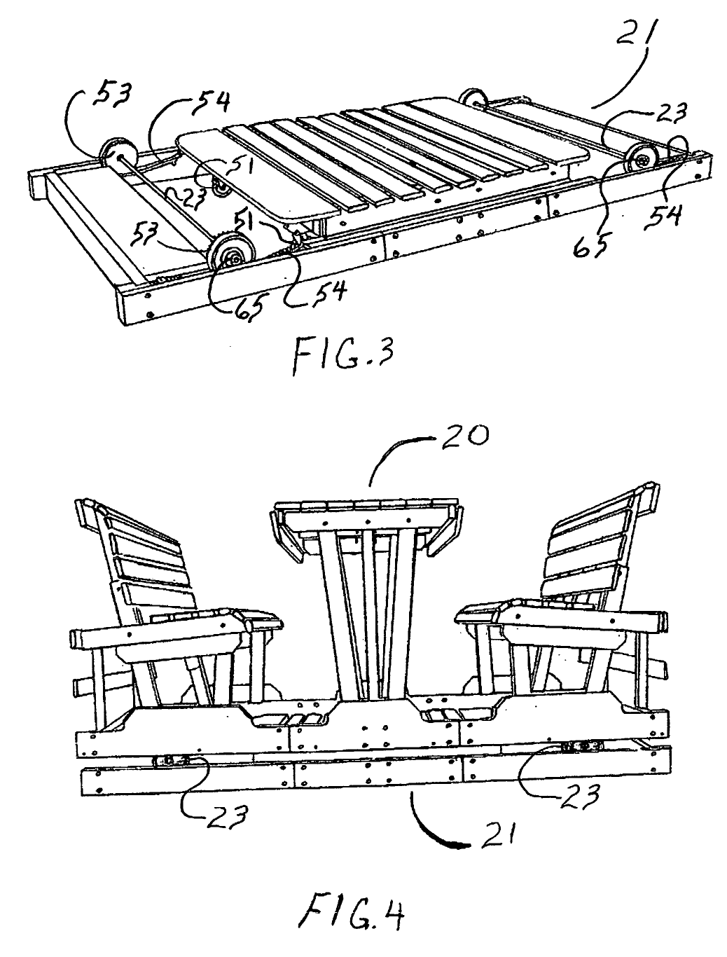

To further describe the preferred embodiment of the apparatus of the present invention attention should be given to FIGS. 2, 3, 4 and 13. FIG. 3 prospectively depicts 21 Lower frame assembly with 23 Axle and gliding wheel assemblies in there prospective positions.

23 Axle and gliding wheel assemblies consist of 64 Axle, two each 53 sprockets and spacer, two each 55 wheels depicted on FIG. 13 and two each 65 Push retainers depicted on FIG. 3. The axles 23 are configured as to affix by welding or other means to the axle the sprockets parallel and symmetrically timed opposing each other at a desired distance as to locate centered within the receiving 54 timing chain. Sprockets 53 employ a 59 sprocket timing mark. 40 and 41 Gliding frames also employ 60 Timing marks. One each 23 Axle and gliding wheel assembly are placed on opposing ends of 21 Lower frame assembly, as depicted in FIG. 3, within 56 Lower frame tracks and 54 timing chains which are affixed to 40 Right gliding frame with timing chain, and 41 Left gliding frame with timing chain as depicted in FIG. 13. The 23 axle assemblies are placed parallel to 42 rear cross support and foot guard, with 59 and 60 Timing marks positioned in line with each other to assure proper alignment of 23 axle assembly within 21 Lower main frame. The 53 sprocket and 54 timing chain prevent unwanted side to side action of the 23 Axle assemblies during use.

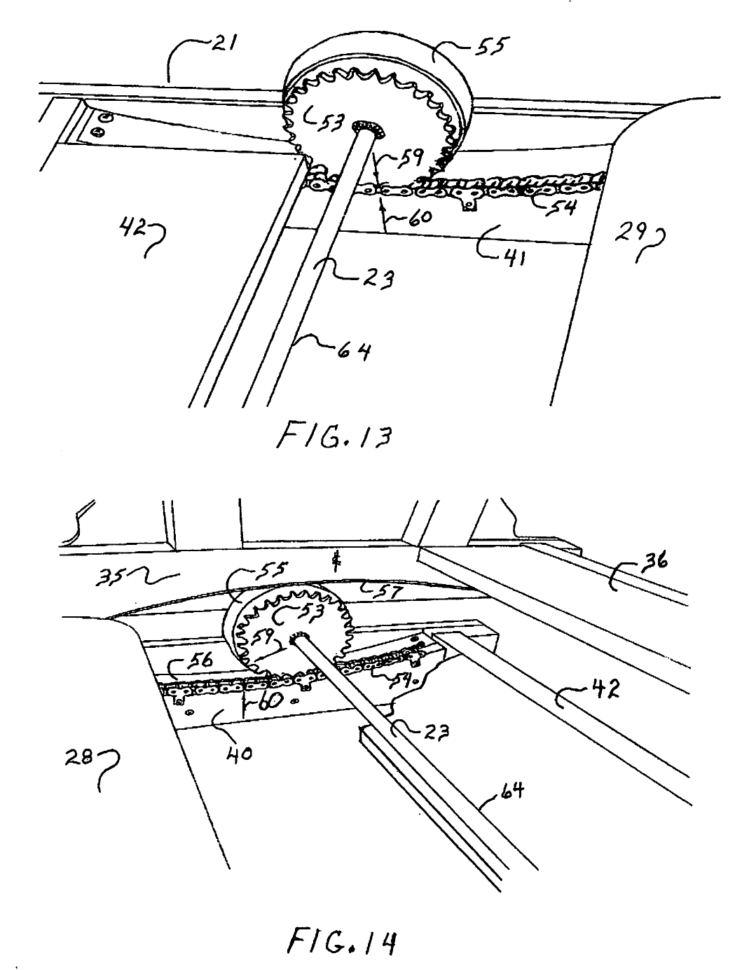

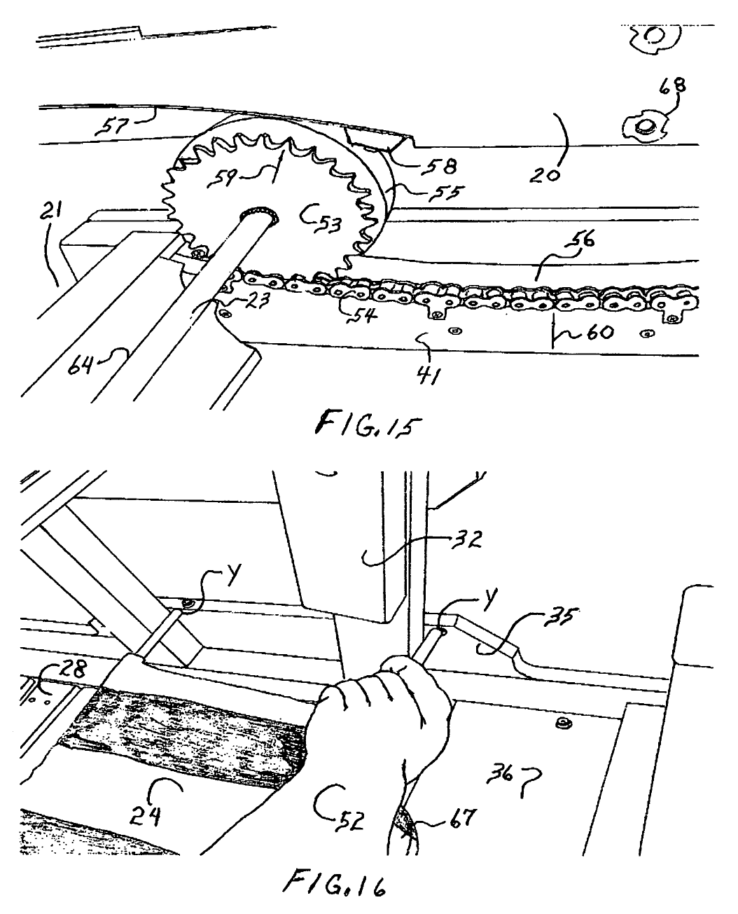

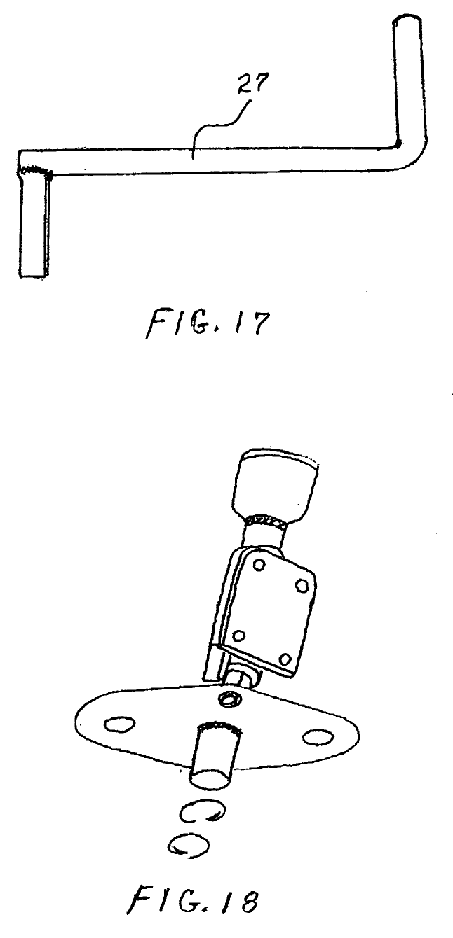

To further describe the preferred embodiment of the apparatus of the present invention, attention should be given to prospective FIGS. 2 and 4. FIG. 2 depicts a separation view of 21 Lower frame assembly below 23 Axle and gliding wheel assemblies, which is below 20 upper main frame assembly. FIG. 4 depicts 21 Lower frame, 23 Axle and gliding wheel assemblies and 20 Upper main frame in their prospective locations. 20 Upper main frame with 57 tracks, as depicted in FIGS. 14 and 15, are located symmetrically over 21 Lower frame assembly and 23 axle assemblies timed in there prospective locations.

To further describe the preferred embodiment of the apparatus of the present invention, attention should be given to the fabric guarding systems prospectively depicted in FIGS. 4, 5 and 16 and the intricate wooden guards prospectively depicted in FIG. 2.

FIG. 5, 25 Fabric side guards, are affixed along the lower edge of 20 Upper frame assembly. 25 Fabric guard employs six, 66 fabric snaps to affix the guard along a line parallel to the bottom edge of 20 upper frame assembly. When in use, 20 upper frame passes over 21 lower frame. The 25 fabric guard travels affixed to 20 upper frame assembly, preventing personal contact with 23 Axle and gliding wheel assembly there by preventing injury from moving parts along the sides.

Fabric guards 24 are positioned under each seat to prevent unwanted contact of moving parts such as the 23 Axle and gliding wheel assembly. The said 24 Fabric guards are configured in a drape style design with two per common rods such as fiberglass or other flexible material suspending the 24 Fabric guards between 34 Left gliding seat and frame assembly and 35 Right gliding seat and frame assembly. The said rods are located in and flexed by, 52 assembler to a point that allows them to enter and retain themselves in opposing pockets Y as depicted on FIG. 16. A flap extending to the rear of 24 Fabric guard is affixed to 36 Rear cross supports by employment of four 66 Fabric snaps. Said snaps are located in an evenly spaced parallel line along the shorter rearward segments of the rectangle of 21 lower frame assembly on 36 Rear cross supports. A second 67 front flap extends downward from said 24 Fabric guard. Said front flap is freely suspended and is in place to drape an area between the upper side of 24 fabric guard and 28 and 29 floor boards. Said 24 Fabric guard is designed to absorb unwanted contact via fiberglass or alike rods with the 26 operator's legs or other body members by providing a flexible safety guard over 23 Axle assembly and 20 and 21 Track and timing chain areas. 24 Fabric guard is also affixed by means of two each 66 snaps located at common positions Z as depicted on FIG. 5.

FIG. 2, 42 Rear cross support, when in place on assembly 21 has a portion extending generally horizontal from the upper edge of assembly 21 inward enough and wide enough to prevent unwanted entanglement of body parts such as feet or ankles between 20 Upper frame assembly and 21 Lower frame assembly as 20 passes over 21 during use.

FIG. 2, 36 rear cross support, provides a portion thereof expending horizontally in the general direction of under the seat extending outwardly between 34 and 35 Left and Right seat and gliding frames. This surface extends a ridge surface that provides the structure to mount the said 24 fabric guard snaps. It also provides a solid barrier between the 24 fabric guard and 37 rear guard to prevent accidental entrance to moving parts.

37 Rear guard depicted on FIGS. 2 and 7 generally A shaped is affixed to 36 rear cross support. Guard 37 is designed to prevent undesired entry to the area generally under the 33 seat bottoms. 37 Rear guard also serves to bump objects out of the path of the glider in motion.

To further describe the operation and motion of the preferred embodiment of the present invention must be given to FIGS. 5, 14 and 15. FIG. 5 depicts the 26 operator pushing with the feet against 28 Floor board to begin the gliding motion of 20 Upper frame assembly over 21 lower frame assembly. A positional change of 20 over 21 can be noted on the lower left portion of FIG. 5. As 26 operator relaxes the pressure on their feet, the concave and convex tracks of 35 Right seat and gliding frame and 40 Right gliding frame with timing chain of FIG. 14 urge the upper gliding frame in the opposite direction. This process of lightly pushing and relaxing and the kinetic energy stored can continue until a maximum travel is reached and the 58 travel stop is then employed preventing over travel of the system. The travel stops, as depicted in FIG. 15, are in four common locations on 35 Right seat and gliding frames and 34 Left seat and gliding frames. The system will continue with nearly effortless involvement of the 26 operator. When operator 26 desires to stop the movement they simply relax their pressure allowing the system to glide several strokes into a motionless position.

To further describe the preferred embodiment of the present invention. Consideration has been given to size and shape of the packaging of Gliding. Table and Chairs. The current invention will be transported in two packages no larger than 50 inches or 1270 mm long×29 inches or 736.6 mm wide×21 inches or 533.4 mm tall or 150 inches length and girth. This will allow the transport of the packages by common carriers such as FedEx and UPS.

### PARTS LIST

The following is a list of parts and materials suitable for use in the present invention:

### Parts Number

### Description

20 Upper Frame Assembly
21 Lower Frame Assembly
22 N/A
23 Axle and Gliding Wheel Assembly
24 Fabric Axle Guard
25 Fabric Side Guard
26 Operator
27 Crank
28 Foot Board with Lifting Mechanism
29 Foot Board with Transport Wheels
30 a
31 Table Leg
32 Seat Back
33 Seat Bottom
34 Left Seat and Gliding Frame
35 Right Seat and Gliding Frame
36 Rear Cross Support
37 Rear Guard
38 Key Board
39 Foot Boards
40 Right Gliding. Frame w/timing chain
41 Left Gliding Frame w/timing chain
42 Rear Cross Support and Foot Guard
43 Frame Locking Side Board
44 Key Board
45 Twisting Transport Lift Mechanism
46 Transport Wheel and Axle Assembly
47 Opposite Transport Wheel Axle Assembly
48 Lifting Spring
49 Lifting Connecting Rod
50 Lifting Connecting Rod w/spring bracket
51 Transport Wheels
52 Assembler
53 Sprocket and Spacer
54 Timing Chain
55 Wheels
56 Lower Frame Track
57 Upper Frame Track
58 Travel Stop
59 Sprocket Timing Mark
60 N/A
61 Wooden Frame
62 Wooden Frame
63 Eye Screw
64 Axle
65 Push on Retainer
66 Snaps
67 Cloth Front Flap
68 Tee Nut

### Hardwear

A ¼-20×4½ Slotted Pan Head bolts with ¼ washer
B ¼-20×3 inches Slotted Pan Head with ¼ Washer
C 5/16-18×3 inch Slotted Pan Head with Washer
D 5/16-18×2½ inches Slotted Pan Head With washers
E 5/16-18×2¼ inches Slotted Pan Head With washer
F 5/16-18×4 inches Slotted Pan Head with Washer
G 5/16-18×3 inches Carriage Bolt with 5/16 Washer, Loc Washer & Nut
H 5/16-18×4½ inches Carriage Bolt with 5/16 Washer, Loc Washer & Nut
I Cotter Pen

What is claimed:

1. A table and chair mechanism witch moves forward and backward as one in a gliding motion comprising of an upper and lower frame and two axle assembles. The said axle assembles are comprised of two wheels attached at the farthest ends of each axle. Said axle and wheels are positioned between upper and lower frame assemblies on four tracks provided in frames. The upper rectangle frame consisting of two bench style seats is positioned on a frame with a table centered between the seats. A lower frame assembly, symmetrical to the upper frame, with foot boards and tracks to support the axle and wheels which will in turn support the upper frame positioned symmetrically over and on top of the lower frame axle and wheels.

2. A mechanism which moves forward and backward as one assembly in a gliding motion comprising of an upper and lower frame assembly, and two axle assembles consisting of two axles and four wheels. Two wheels are positioned at the outer most ends of each axle. The said wheel and axle assemblies are located in symmetrically positioned convex tracks in the upper frame and concave tracks located in the lower frame. Said tracks are symmetrically positioned along the rectangular frames at the intersecting corners. Said tracks are positioned within and parrell to the longer sides of the frames.

3. A table and chair mechanism where opposing concave/convex tracks are symmetrically located on the opposing four corners of the upper and lower frames. Said upper frame including table and chairs and four convex tracks positioned on the underside of the frame, parrell to the longer sides of the rectangle near each entersecting corner. Lower frame and foot boards employing concave tracks positioned on the upper side of said lower frame, parrell to the longer sides of the rectangle frame near each intersecting corner. Upper and lower frames include side boards which are positioned along the outer edge of the concave/convex tracks. Positioned between the upper and lower frames and with in the said concave/convex tracks of the upper and lower frames are four wheels of suitable size to fill the void of the concave and convex tracks and separate the upper and lower frames by approximately one inch. The four wheels of the table and chair assembly ride spaced apart and rotate freely on axles, separating the wheels on opposing ends of the rectangle style frame.

4. A table and chair assembly of claim 3, where the axles use of two sprockets each joined to the axles and spacers between the sprockets and wheels to maintain the proper distance between said wheels. Said wheels then are held in a side to side separation and track within said concave/convex tracks and side boards maintaining the symmetrical positioning of the upper frame over the lower frame.

5. A table and chair assembly of claim 3, where the said wheels of the table and chairs assembly ride and rotate freely on axles. The axle and wheel assembly include sprockets affixed to the axle at positions adjacent to the wheels allowing the sprockets to be positioned over the concave track and into the convex tracks. The sprockets are positioned in sections of chain which are affixed within the said concave tracks of the lower frame. Said sprockets and chains now become timing chains and sprockets which work together to maintain axle parallelism between the opposite ends of the frame. Said sprocket and chains control lateral motion of the axle assembly within the lower frame and tracks.

6. A table and chairs mechanism of claims 1 and 3 with dimensions of 85 inches long×48 inches wide×42 inches tall comprising of an upper frame including a table and chairs. A lower frame assembly and axle wheel assemblies that can be packaged in kit form. Said table and chairs kit is in sectional components to fit a packaging container of 150 inches length and girth combined.

7. A table and chairs mechanism of claims 1 and or 3 consisting of an upper frame and lower frame and axle and wheel assemblies that are located between said upper and lower assemblies. Said lower frame assembly includes a retractable transport wheel system. Said system includes four caster style wheel assemblies on the underside of the lower frame/footboard assembly. Said wheel assemblies are affixed to two axle shafts that when are in use are rotated and locked into the extended or transport position. A crank/twist mechanism that urges two opposing rods inward and force the rotation of the caster wheel axles into the raised position. Rotating crank in the opposite direction urges the two opposing rods outward twisting the caster and wheel assemblies into the lower retracted position.
